(19) United States
(12) Patent Application Publication
(10) Pub. No.: US 2019/0181480 A1
(43) Pub. Date: Jun. 13, 2019

(54) MEMBRANE ELECTRODE ASSEMBLY, FUEL CELL PROVIDED WITH SAME, AND METHOD FOR PRODUCING MEMBRANE ELECTRODE ASSEMBLY

(71) Applicant: Panasonic Intellectual Property Management Co., Ltd., Osaka (JP)

(72) Inventors: MASASHI SHOJI, Kyoto (JP); HITOSHI ISHIMOTO, Hyogo (JP); SHINICHIRO IMURA, Hyogo (JP); HIROAKI SUZUKI, Osaka (JP)

(21) Appl. No.: 16/274,237

(22) Filed: Feb. 13, 2019

Related U.S. Application Data
(63) Continuation of application No. PCT/JP2017/027422, filed on Jul. 28, 2017.

(30) Foreign Application Priority Data
Sep. 1, 2016 (JP) 2016-171251

(51) Int. Cl. H01M 8/1004; H01M 4/86; H01M 8/0202

(52) U.S. Cl. CPC H01M 8/1004; H01M 2008/1095; H01M 8/0202; H01M 4/8657

(57) ABSTRACT

Provided is a membrane electrode assembly capable of keeping contact resistance between a catalyst layer and a gas diffusion layer (GDL) low. The membrane electrode assembly includes an electrolyte membrane and a pair of electrode layers disposed to sandwich the electrolyte membrane. The pair of electrode layers includes a pair of catalyst layers disposed to sandwich the electrolyte membrane, and a pair of GDLs disposed on opposite sides of the electrolyte membrane on the respective pair of catalyst layers. Each of the pair of GDLs includes a plurality of GDL protrusions that protrude on a catalyst layer side from the GDL and enter in the catalyst layer, and a gas flow path formed on an opposite side of the catalyst layer. Each of the pair of catalyst layers has a plurality of catalyst layer recesses in contact with the respective plurality of GDL protrusions.

### BACKGROUND

### 1. Technical Field

The present disclosure relates to a membrane electrode assembly (MEA) used for a fuel cell, a fuel cell provided with the same, and a method for producing the MEA.

### 2. Description of the Related Art

A fuel cell typically includes a laminated plurality of cells, and the plurality of cells are press-fastened by a fastening member. The cell includes a membrane electrode assembly (hereinafter, referred to as MEA) having an electrolyte membrane and a pair of electrodes (anode and cathode) sandwiching the electrolyte membrane. The electrodes include a catalyst layer in contact with the electrolyte membrane, and a gas diffusion layer laminated on the catalyst layer. A pair of separators is disposed on outer sides of the respective gas diffusion layers of the MEA. A fluid flow path is formed between the gas diffusion layer and the separator, and gaseous fuel and oxidant are supplied to each electrode via the flow path.

In this manner, in the fuel cell, a plurality of constituent members is laminated, so that adhesiveness between adjacent constituent members affects contact resistance. PTL 1 has proposed to increase roughness of a surface of a gas diffusion layer on a catalyst layer side in order to reduce contact resistance.

### CITATION LIST

### Patent Literature

PTL 1: WO 2011/045889

### SUMMARY

Although a fluid flow path that is a space between the gas diffusion layer and the separator is formed, a fastening pressure is less likely to be applied to a portion on a boundary face between the layers positioned above or below the fluid flow path when the catalyst layer and the gas diffusion layer are simply overlapped. Furthermore, there is a case where the gas diffusion layer disadvantageously floats from the catalyst layer due to pressure of water generated by power generation. Accordingly, the contact resistance is difficult to be kept low.

An aspect of the present disclosure relates to a membrane electrode assembly that includes an electrolyte membrane and a pair of electrode layers disposed to sandwich the electrolyte membrane. The pair of electrode layers includes a pair of catalyst layers disposed to sandwich the electrolyte membrane, and a pair of gas diffusion layers disposed opposite sides of the electrolyte membrane and disposed respectively on the catalyst layers in the pair. Each of the pair of gas diffusion layers has a plurality of gas diffusion layer protrusions (GDL protrusions) that protrude towards a corresponding one of the catalyst layers from the gas diffusion layer and enter corresponding one of the catalyst layers, and a gas flow path disposed opposite corresponding one of the catalyst layers. Each of the pair of catalyst layers has a plurality of catalyst layer recesses in contact with the respective plurality of GDL protrusions.

Another aspect of the present disclosure relates to a fuel cell that includes the above-mentioned membrane electrode assembly, and a pair of separators disposed to sandwich the membrane electrode assembly via the pair of gas diffusion layers.

A still another aspect of the present disclosure relates to a method for producing a membrane electrode assembly that includes a preparation step, a laminated body forming step, and a press molding step. The preparation step is for preparing an electrolyte membrane sandwiched by a pair of catalyst layers, and a pair of gas diffusion layers. The laminated body forming step is for disposing the pair of gas diffusion layers on opposite sides of the electrolyte membrane on the respective pair of the catalyst layers to form a laminated body.

The press molding step is for sandwiching the laminated body by a pair of molds and pressing the pair of gas diffusion layers to form a plurality of GDL protrusions, a gas flow path, and a plurality of catalyst layer recesses. Herein, the pair of molds has a protrusion for forming a gas flow path. The plurality of GDL protrusions are formed to protrude towards a corresponding one of the catalyst layers from the gas diffusion layer and enter the corresponding one of the catalyst layers on the catalyst layer gas diffusion layer side. The gas flow path is disposed opposite corresponding one of the catalyst layers on the gas diffusion layer. The plurality of catalyst layer recesses are formed on a gas diffusion layer side on the catalyst layer.

The present disclosure makes it possible to keep a contact resistance between the catalyst layer and the gas diffusion layer of the MEA low.

### BRIEF DESCRIPTION OF THE DRAWINGS

FIG. 1 is a vertical cross-sectional view schematically illustrating an MEA according to an exemplary embodiment of the present disclosure;

FIG. 2A is a cross-sectional view illustrating a step of a method for producing the MEA according to the exemplary embodiment of the present disclosure;

FIG. 2B is a cross-sectional view illustrating a step of the method for producing the MEA; and

FIG. 2C is a cross-sectional view illustrating a step of the method for producing the MEA.

### DETAILED DESCRIPTION

A membrane electrode assembly (MEA) according to an exemplary embodiment of the present disclosure includes an electrolyte membrane and a pair of electrode layers disposed to sandwich the electrolyte membrane. The pair of electrode layers includes a pair of catalyst layers disposed to sandwich the electrolyte membrane, and a pair of gas diffusion layers (GDLs) disposed on opposite sides on the respective pair of catalyst layers. Each of the pair of GDLs has a plurality of gas diffusion layer protrusions (GDL protrusions) that protrude towards a corresponding one of the catalyst layers from the GDL and enter in the catalyst layer, and a gas flow path disposed opposite the corresponding one of the catalyst layers. Each of the pair of catalyst layers has a plurality of catalyst layer recesses in contact with the respective plurality of GDL protrusions.

Such an MEA is produced by a producing method that includes a preparation step, a laminated body forming step, and a press molding step. The preparation step is for preparing an electrolyte membrane sandwiched by a pair of catalyst layers, and a pair of GDLs. The laminated body forming step is for disposing the pair of GDLs on sides opposite to the electrolyte membrane on the respective pair of catalyst layers to form a laminated body.

The press molding step is for sandwiching the laminated body by a pair of molds and pressing the pair of gas diffusion layers to form a plurality of GDL protrusions, a gas flow path, and a plurality of catalyst layer recesses. Herein, the pair of molds has a protrusion for forming a gas flow path. The plurality of GDL protrusions are formed to protrude towards a corresponding one of the catalyst layers from the GDL and enter the corresponding one of the catalyst layers on the catalyst layer GDL side. The gas flow path is disposed opposite corresponding one of the catalyst layers on the GDL. The plurality of catalyst layer recesses are formed on a GDL on the catalyst layer.

In this manner, in the exemplary embodiment, the plurality of GDL protrusions that protrude on the catalyst layer side from the GDL is formed to enter in the catalyst layer, that is, formed to bite the catalyst layer, and the plurality of catalyst layer recesses are formed on the GDL side on the catalyst layer by the biting of the GDL protrusions. In other words, the plurality of catalyst layer recesses are in contact with the respective plurality of gas diffusion layer protrusions. Then, irregularity on a boundary face between the GDL and the catalyst layer is formed by pressing the GDL by a protrusion of a mold when forming a gas flow path on an opposite side of the catalyst layer on the GDL by press working by molds having the protrusion for forming the gas flow path. A portion of the GDL pressed by the protrusion of the mold protrudes on the catalyst layer side to form the GDL protrusion, and at the same time when the GDL protrusion is formed, the catalyst layer recess is formed on the GDL side on the catalyst layer by being pressed by the GDL protrusion. Formation of the GDL protrusion and the catalyst layer recess at the same time increases adhesive strength between the GDL protrusion and the catalyst layer recess due to anchor effect, making it possible to reduce contact resistance as compared with a case where the catalyst layer and the GDL are simply overlapped. Furthermore, biting (entering) of the gas diffusion layer in the catalyst layer makes gas to be readily diffused in the catalyst layer, making it possible to also improve power generation properties in a high current density region.

Irregularity on the boundary face between the GDL and the catalyst layer is formed at a position where the gas flow path of the GDL is formed. That is, the plurality of GDL protrusions of the GDL is formed along the gas flow path on the opposite side of the catalyst layer of the GDL. Furthermore, the plurality of GDL protrusions are formed in a projection region of the gas flow path when the gas flow path of the GDL is projected toward the catalyst layer in the thickness direction of the MEA. Accordingly, anchor effect is exerted due to irregularity (catalyst layer recesses and GDL protrusions) at the boundary face between the GDL and the catalyst layer, which can suppress floating of the GDL even when water is generated during power generation, making it possible to suppress contact resistance to be low and improve durability of the MEA.

The catalyst layer is divided into a first region that is a projection region in a case where the catalyst layer recess is projected toward the electrolyte membrane in the thickness direction of the membrane electrode assembly, and a second region other than the first region. The catalyst layer recess is formed by being pressed by the GDL protrusion when the GDL protrusion is formed. This lowers a void ratio of the catalyst layer in the first region than a void ratio of the catalyst layer in the second region. Gas readily enters in the first region due to biting of the GDL protrusion, enabling to enhance reaction efficiency of power generation. In contrast, in the second region where gas is less likely to enter as compared with the first region, void ratio of the catalyst layer is high, which enables gas diffusion route to be secured. This makes it possible to reduce unbalance between supply and reaction of gas in the catalyst layer, making it possible to suppress regional reaction concentration while effectively utilizing whole catalyst layer. This makes it possible to perform power generation more evenly in the whole catalyst layer. Furthermore, void ratio is low in the region of the catalyst layer opposing the gas flow path, making it possible to reduce resistance of the catalyst layer. This makes it possible to enhance efficiency of taking out current from the first region where distance from the separator becomes far due to existing of the gas flow path, making it possible to improve power generation properties of the MEA in a high current density region.

In the MEA, the pair of catalyst layers is an anode catalyst layer and a cathode catalyst layer. An average depth of the plurality of catalyst layer recesses formed on the cathode catalyst layer may be equal to or smaller than an average depth of the plurality of catalyst layer recesses formed on the anode catalyst layer, but a diffusion coefficient of anode gas is larger than a diffusion coefficient of cathode gas. Accordingly, an average depth of the plurality of catalyst layer recesses formed on the cathode catalyst layer is preferably larger than an average depth of the plurality of catalyst layer recesses formed on the anode catalyst layer. When the average depth of the plurality of catalyst layer recesses is larger in the cathode catalyst layer than that in the anode catalyst layer, diffusion distribution behavior of anode gas and diffusion distribution behavior of cathode gas come close in two sides of the electrolyte membrane. This enables to enhance power generation efficiency of the MEA.

In the above producing method, in the press molding step, it is preferable that the protrusion of one of the pair of molds and the protrusion of another of the pair of molds are disposed at positions overlapped in a thickness direction of the MEA. In this case, by the press molding, a plurality of GDL protrusions are simultaneously formed at overlapped positions in the anode side GDL and the cathode side GDL, making it possible to suppress positional deviation of the GDL protrusions.

Note that, the overlapped position of the protrusion of one of the molds and the protrusion of the other of the molds in the thickness direction of the MEA (that is, stacking direction of the electrolyte membrane, the catalyst layer, the GDL and the separator) denotes a state where the protrusion of one of the molds are overlapped with the protrusion of the other of the molds when the protrusion of one of the molds is projected toward the other of the molds in the thickness direction of the MEA. Overlapping of corresponding projections may be partial. For example, it is preferable that overlapping of a projection area of the protrusion of one of the molds and a projection area of the protrusion of the other of the molds be not less than 80%. Specifically, it is preferable that centers (positions where height of protrusions are most high) of respective protrusions are overlapped with each other. That is, in both GDLs, it is preferable that overlapping of projection areas of GDL protrusions opposed to each other be not less than 80%, and in particular, it is preferable that centers (or positions where heights of the GDL protrusions are most high) of respective GDL protrusions be overlapped with each other.

The MEA according to the exemplary embodiment is used for a fuel cell. The fuel cell includes the above-mentioned membrane electrode assembly, a pair of separators disposed to sandwich the membrane electrode assembly via the respective pair of gas diffusion layers, and such a fuel cell is also included in the present disclosure.

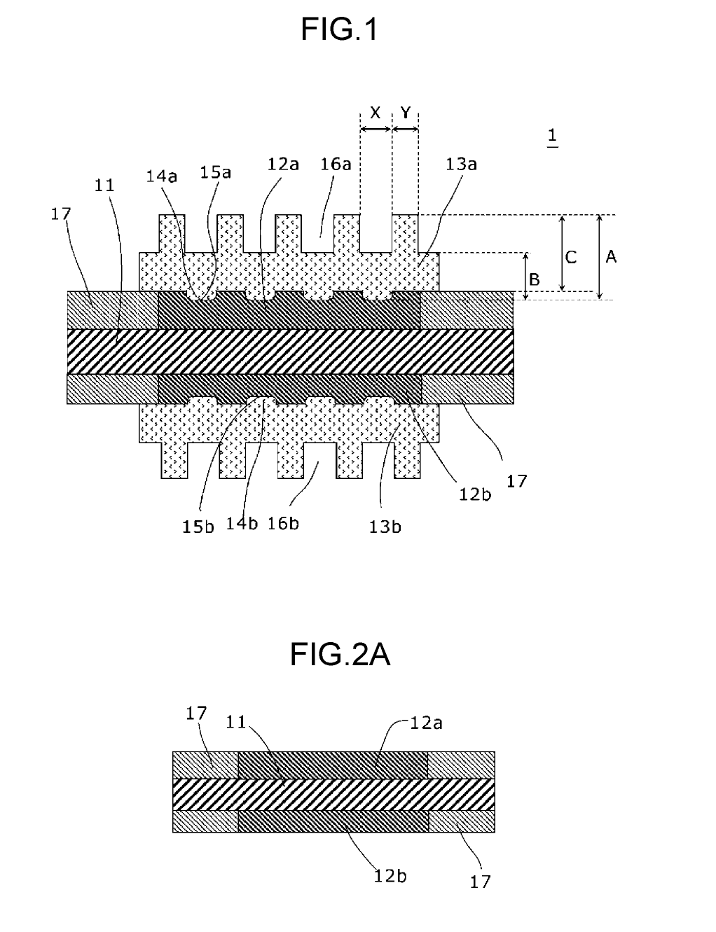

FIG. 1 is a vertical cross-sectional view schematically illustrating an MEA according to an exemplary embodiment of the present disclosure. MEA 1 includes electrolyte membrane 11, and a pair of electrode layers formed of a cathode and an anode sandwiching electrolyte membrane 11. The pair of electrode layers includes a pair of catalyst layers 12a, 12b disposed to sandwich electrolyte membrane 11, and a pair of GDLs 13a, 13b respectively disposed on sides opposite to electrolyte membrane 11 on the pair of catalyst layers 12a, 12b. To be more specific, cathode catalyst layer 12a is disposed on one of main surfaces (main surface on cathode side), and anode catalyst layer 12b is disposed on the other of the main surfaces (main surface on anode side) of electrolyte membrane 11. Sub gasket 17 is disposed around each of catalyst layers 12a, 12b to surround catalyst layers 12, 12b. Cathode side GDL 13a is disposed to be in contact with cathode catalyst layer 12a, and anode side GDL 13b is disposed to be in contact with anode catalyst layer 12b. GDL 13a, 13b respectively include a plurality of GDL protrusions 14a, 14b protruding toward catalyst layer 12a, 12b from GDL 13a, 13b.

GDL protrusion (cathode GDL protrusion) 14a protruding from cathode side GDL 13a bites (enters) into cathode catalyst layer 12a, and the biting of GDL protrusion 14a forms a plurality of catalyst layer recesses (cathode catalyst layer recesses) 15a in the cathode catalyst layer 12a. That is, the plurality of catalyst layer recesses (cathode catalyst layer recesses) 15a is in contact with the respective plurality of GDL protrusions 14a. Likewise, a plurality of GDL protrusions (anode GDL protrusions) 14b protruding from anode side GDL 13b bites (enters) into anode catalyst layer 12b, and the biting forms a plurality of catalyst layer recesses (anode catalyst layer recesses) 15b in the anode catalyst layer 12b. That is, the plurality of catalyst layer recesses (anode catalyst layer recesses) 15b is in contact with the respective plurality of GDL protrusions 14b.

The pair of GDLs 13a, 13b respectively has gas flow paths 16a, 16b formed on opposite sides of catalyst layer 12a, 12b. The plurality of GDL protrusions 14a, 14b is respectively formed along gas flow paths 16a, 16b. In the illustrated example, the plurality of GDL protrusions 14a, 14b extend toward a gas outlet side from a gas inlet side, and is formed to be arranged in a line.

Hereinafter, each constituent element of the MEA and the fuel cell will be specifically described.

Features of the present disclosure are in a structure of a boundary face between catalyst layer and GDL, and any known configuration other than the structure can be used without particular limitation.

### (1) MEA

### (1a) Electrolyte Membrane

Electrolyte membrane 11 is preferably a polymer electrolyte membrane. As the polymer electrolyte membrane, for example, a proton-conducting polymer membrane conventionally used for a fuel cell can be used without particular limitation. To be more specific, a perfluorosulfonic acid based polymer membrane, a hydrocarbon based polymer membrane can be preferably used. Examples of the perfluorosulfonic acid based polymer membrane include Nafion (registered trademark).

Electrolyte membrane 11 has a thickness of, for example, 5 μm to 50 μm inclusive.

### (1b) Catalyst Layer

Each of the pair of catalyst layers 12a, 12b includes, for example, ion exchange resin and catalyst particles, and in some cases carbon particles that support catalyst particles. Ion exchange resin plays a role of connecting catalyst particle and electrolyte membrane and transferring proton between catalyst particle and electrolyte membrane. A polymer material forming electrolyte membrane (polymer electrolyte membrane) 11 can be used as the ion exchange resin. Examples of the polymer material includes perfluorosulfonic acid based polymer and hydrocarbon based polymer.

Examples of the catalyst particles include catalyst metals such as alloys or elemental substances selected from the group consisting of Sc, Y, Ti, Zr, V, Nb, Fe, Co, Ni, Ru, Rh, Pd, Pt, Os, Ir, lanthanoid series elements, and actinoid series elements.

Acetylene black, Ketjen black, carbon nanotube, or the like can be used for carbon particles.

Each of the catalyst layers has a thickness ranging from 3 μm to 40 μm, inclusive, for example.

As described above, it is preferable that a void ratio of the catalyst layer in the first region is lower than a void ratio of the catalyst layer in the second region when the catalyst layer is divided into the first region and the second region other than the first region. A ratio p1/p2 of void ratio p1 of the catalyst layer in the first region and void ratio p2 of the catalyst layer in the second region is, for example, 0.5 to 0.98 inclusive and is preferably 0.8 to 0.95 inclusive. Although it depends on depth of the catalyst layer recess, in a case where p1/p2 ratio is within such a range, uniformity of reaction in the whole catalyst layer can be readily enhanced. Note that void ratios p1 and p2 can be obtained by subjecting a SEM image of a catalyst layer cross section to binarization processing using image processing software. That is, the binarization processing makes it possible to discriminate between catalyst layer component (e.g., catalyst particle, carbon particle, etc.) and void, calculate a ratio of area of void to a predetermined area of the catalyst layer cross section, and estimate the ratio as volume-based void ratio.

The average depth of catalyst layer recess ranges from 0.1 μm to 25 μm inclusive, and preferably ranges from 0.2 μm to 5 μm inclusive, for example. Also, the average depth of the catalyst layer recess ranges from 0.2% to 50% inclusive, and preferably ranges from 4% to 10% inclusive, for example. The average depth of the catalyst layer recess can be obtained by measuring depths of a plurality of (e.g., ten) arbitrary catalyst layer recesses (maximum depth of each catalyst layer recess) in an electron micrograph of a cross section of the MEA, and averaging the measured depths. Note that, since the catalyst layer recess corresponds with the GDL protrusion, an average height of the GDL protrusion is assumed to be the same as an average depth of the above-mentioned catalyst layer recess. The depth of the catalyst layer recess is a distance between a height position where the catalyst layer recess is most retracted, and a height position of middle of most protruding portions of respective two protruding shaped portions sandwiching the catalyst layer recess.

In the fuel cell, hydrogen gas is supplied to the anode side, and oxidant such as oxygen gas is supplied to the cathode side. Hydrogen gas is small in pressure loss as compared with oxidant, so that hydrogen gas is readily passed through the gas flow path, but oxidant is difficult to pass through the gas flow path. Also, water is readily generated due to power generation on the cathode side. Therefore, supply of gas to the cathode may be facilitated by increasing the average depth of the cathode catalyst layer recess than the average depth of the anode catalyst layer recess.

### (1c) GDL

The GDL in a typical MEA includes a conductive water repellent layer and a base layer (conductive porous material, etc.) supporting the conductive water repellent layer. In the exemplary embodiment, like a conventional GDL, a GDL including a base layer and a conductive water repellent layer can be also used. However, irregularity is formed on a boundary face between the GDL and the catalyst layer by pressing by a protrusion of a mold, so that it is preferable that each of the pair of GDLs 13a, 13b does not include a base material, that is, is formed by a conductive water repellent layer.

The conductive water repellent layer includes a conductive agent and a water repellent agent. As to the conductive agent included in the conductive water repellent layer, a known conductive material used in a field of fuel cell such as carbon black can be used without particular limitation. As to the water repellent agent included in the conductive water repellent layer, a known material used in a field of fuel cell such as fluorine resin (e.g., polytetrafluoroethylene) can be used without particular limitation.

The plurality of GDL protrusions is formed with formation of the gas flow path, so that it is formed along the gas flow path. A shape of the GDL protrusion corresponds to a shape of the gas flow path. For example, when a linear gas flow path is formed, a linear GDL protrusion is formed, and when a serpentine-shaped gas flow path is formed, a serpentine-shaped GDL protrusion is formed.

An average height of the GDL protrusion can be determined from the same range as the average depth of the above-mentioned catalyst layer recess.

An average distance of adjacent GDL protrusions ranges from 0.2 mm to 1 mm inclusive, and preferably ranges from 0.2 mm to 0.8 mm inclusive, for example. Note that, the average distance of the GDL protrusions can be obtained by calculating center to center distances (that is, distances) between a plurality of (e.g., ten) arbitrarily selected GDL protrusions and GDL protrusions adjacent thereto in an electron micrograph of a cross section of the MEA, and averaging the calculated distances. When the average distance is within such a range, reaction can be made to progress evenly in the whole catalyst layer.

The GDL has an average thickness, for example, ranging from 100 μm to 600 μm inclusive. An average thickness of the cathode side GDL preferably ranges from 150 μm to 600 μm. An average thickness of the anode side GDL preferably ranges from 100 μm to 500 μm inclusive. Herein, the thickness of the GDL is a distance between a top of the GDL protrusion and a top of portions protruding to sandwich the fluid flow path of the GDL, and is size A in FIG. 1.

An average thickness of a portion of the fluid flow path of the cathode side GDL ranges from 50 μm to 200 μm inclusive, for example, and an average thickness of a portion of the fluid flow path of the anode side GDL ranges from 50 μm to 200 μm inclusive, for example. The portion of the fluid flow path of the cathode side GDL is an area expressed by X in FIG. 1, and the thickness of the fluid flow path of the cathode side GDL is size B in region X in FIG. 1 The thickness of the fluid flow path of the anode side GDL can be obtained in conformity to the case of the cathode side GDL.

Furthermore, an average thickness of a portion other than the fluid flow path of the GDL ranges from, for example, 130 μm to 600 μm inclusive on the cathode side, and ranges from, for example, 70 μm to 500 μm inclusive on the anode side. The portion other than the fluid flow path of the GDL is a region expressed by Y in FIG. 1. A thickness of the portion other than the fluid flow path of the GDL is a thickness of the GDL at portions protruding to sandwich the fluid flow path of the GDL, and is size C in region Yin FIG. 1. A thickness of the portion other than the fluid flow path of the anode side GDL can be obtained in conformity to the case of the cathode side GDL.

Note that, the average thicknesses can be obtained by measuring a thickness of each portion for a plurality of arbitrarily selected portions (e.g., ten portions) in an electron micrograph of a cross section of the MEA, and averaging the calculated thicknesses.

### (1d) Sub Gasket

Sub gasket 17 is disposed to surround a rim of catalyst layer 12a, 12b in a looped shape. In the illustrated example, the sub gasket is disposed to surround only catalyst layer, but the present disclosure is not limited thereto, and the sub gasket may be disposed to surround both the catalyst layer and the GDL. An adhesive layer may be formed between the sub gasket and the catalyst layer (and the GDL) as needed. A known sub gasket and a known adhesive constituting the adhesive layer are used. Examples of the adhesive include a thermosetting resin and a thermoplastic resin. The sub gasket may be made of a thermosetting resin or may be made of a thermoplastic resin. Also, the sub gasket may include reinforcement such as a fiber.

### (2) Fuel Cell

The fuel cell includes the above-mentioned MEA, and a pair of separators disposed to sandwich the MEA via the respective pair of GDLs. Furthermore, the fuel cell may include a plurality of laminated single cells each having the MEA and the separator. In the fuel cell having a plurality of cells, single cells are laminated such that a separator is interposed between adjacent MEAs. In the above-mentioned MEA, even in a case where a plurality of cells are laminated and press-fastened, contact resistance can be suppressed to be low.

### (2a) Separator

A known material can be used for the separator without particular limitation. Examples of the material of the separator include, for example, a carbon material and a metal material. Carbon may be coated on the metal material.

A flow path for supplying cooling medium (cooling water, etc.) may be formed on a main surface of the separator opposite to the GDL side.

The separator has a thickness ranging from, for example, 50 μm to 500 μm inclusive.

### (3) Method for Producing MEA

The above-mentioned MEA can be produced by a producing method including a step of preparing an electrolyte membrane sandwiched by a pair of catalyst layers, and a pair of gas diffusion layers, a step of forming a laminated body by disposing the pair of gas diffusion layers on opposite sides of the electrolyte membrane on the respective pair of the catalyst layers, and a step of press-molding the laminated body.

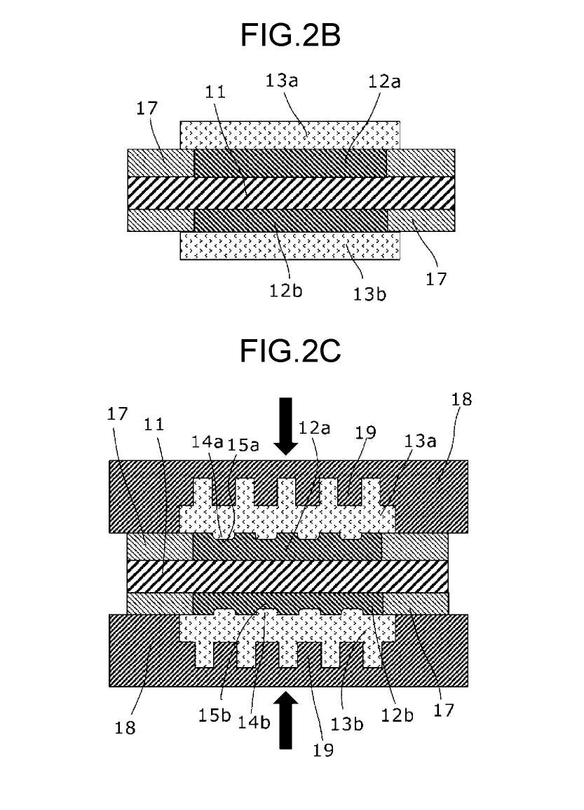

FIGS. 2A to 2C each illustrate a step of the method for producing the MEA of FIG. 1. The producing steps of the MEA proceed in order of FIG. 2A, FIG. 2B, and FIG. 2C.

First, as illustrated in FIG. 2A, both main surfaces of electrolyte membrane 11 are sandwiched by a pair of catalyst layers 12a, 12b. Sub gaskets 17 are previously disposed in a region positioned outside respective rims of catalyst layers 12a, 12b of electrolyte membrane 11 before sandwiching electrolyte membrane 11 by catalyst layers 12a, 12b. The catalyst layers 12a, 12b may be formed on the main surfaces of electrolyte membrane 11 by direct application, or may be separately produced to be laminated on electrolyte membrane 11.

Next, as illustrated in FIG. 2B, a pair of GDLs 13a, 13b separately prepared is disposed on main surfaces of the catalyst layers 12a, 12b sandwiching catalyst layer 11 on opposite sides of the electrolyte membrane 11 to cover the respective catalyst layers 12a, 12b to form a laminated body.

In the steps so far, respective known procedures can be employed.

Then, in the subsequent press molding step, a gas flow path is formed by pressing the laminated body using a mold such as a pair of metal molds 18 having protrusion 19 for forming the gas flow path, and at the same time, irregularity is formed on a boundary face between the GDL 13a, 13b and catalyst layer 12a, 12b. To be more specific, first, the laminated body is sandwiched by the pair of metal molds 18 having protrusion 19. At this time, the pair of metal molds 18 is arranged to face each other such that protrusions 19 of respective metal molds 18 are opposed to each other (that is, in contact with GDLs 13a, 13b) to sandwich the laminated body.

Then, as illustrated in FIG. 2C, the laminated body is pressed so as to be sandwiched by protrusions 19 of metal molds 18. The gas flow paths (gas flow paths 16a, 16b in FIG. 1) are formed on respective main surfaces of GDL 13a, 13b pressed by protrusions 19 on opposite sides of catalyst layers 12a, 12b. At the same time as the formation of the gas flow paths, in regions pressed by protrusions 19, GDLs 13a, 13b respectively protrude toward catalyst layers 12a, 12b to form GDL protrusions 14a, 14b. Formation of the GDL protrusion 14a, 14b makes regions of the respective main surfaces of catalyst layer 12a, 12b on GDLs 13a, 13b sides opposing GDL protrusions 14a, 14b depressed to form catalyst layer recesses 15a, 15b of catalyst layers 12a, 12b at portions respectively opposing GDL protrusions 14a, 14b.

In the press molding step, it is preferable that protrusion 19 of one of metal molds 18 and protrusion 19 of the other of metal molds 18 are disposed at positions overlapped in a thickness direction of the MEA (that is, stacking direction of the laminated body). By making the positions of protrusions 19 of respective metal molds 18 overlapped with each other, positions of GDL protrusions 14a, 14b to be formed can be overlapped with each other.

In this manner, irregularity can be formed between the GDL and the catalyst layer along with formation of the gas flow path. Accordingly, different from the case where each layer is separately produced for lamination, or sequentially laminated, positional deviation between GDL protrusions on anode side and cathode side can be suppressed.

Note that, in the producing method in the exemplary embodiment, although a metal mold is used as a mold, the present disclosure is not limited thereto. A mold other than metal mold, for example, a mold made of a resin such as polytetrafluoroethylene (PTFE) can be used.

The MEA according to the present disclosure is suitable for, for example, a fuel cell used for an automobile, a mobile electronic device, a power source for outdoor leisure, an emergency back-up power source, and the like.

What is claimed is:

1. A membrane electrode assembly comprising:
an electrolyte membrane; and
a pair of electrode layers disposed to sandwich the electrolyte membrane,
wherein the pair of electrode layers includes a pair of catalyst layers disposed to sandwich the electrolyte membrane, and a pair of gas diffusion layers disposed opposite the electrolyte membrane and disposed respectively on the catalyst layers in the pair,
each of the pair of gas diffusion layers includes a plurality of gas diffusion layer protrusions that protrude towards a corresponding one of the catalyst layers from the gas diffusion layer and enter the corresponding one of the catalyst layers, and a gas flow path disposed opposite the corresponding one of the catalyst layers, and
each of the pair of catalyst layers includes a plurality of catalyst layer recesses in contact with the respective plurality of gas diffusion layer protrusions.

2. The membrane electrode assembly according to claim 1, wherein the plurality of gas diffusion layer protrusions are disposed along the gas flow path.

3. The membrane electrode assembly according to claim 2, wherein the plurality of gas diffusion layer protrusions are disposed in a projection region of the gas flow path when the gas flow path of the gas diffusion layer is projected toward the corresponding one of the catalyst layers along a thickness of the membrane electrode assembly.

4. The membrane electrode assembly according to claim 1, wherein each of the pair of the catalyst layer is divided into a first region that is a projection region defined by projecting the catalyst layer recesses toward the electrolyte membrane along a thickness of the membrane electrode assembly, and a second region other than the first region, and a void ratio of the catalyst layer in the first region is lower than a void ratio of the catalyst layer in the second region.

5. The membrane electrode assembly according to claim 1, wherein the pair of catalyst layers includes an anode catalyst layer and a cathode catalyst layer, and
an average depth of the plurality of catalyst layer recesses disposed on the cathode catalyst layer is larger than an average depth of the plurality of catalyst layer recesses disposed on the anode catalyst layer.

6. A fuel cell comprising:
the membrane electrode assembly according to claim 1; and
a pair of separators disposed to sandwich the membrane electrode assembly via the pair of gas diffusion layers.

7. A method for producing a membrane electrode assembly, the method comprising:
preparing an electrolyte membrane sandwiched by a pair of catalyst layers, and a pair of gas diffusion layers;
disposing the pair of gas diffusion layers opposite the electrolyte membrane and disposed respectively on the catalyst layers in the pair to form a laminated body; and
sandwiching the laminated body by a pair of molds each having a protrusion for forming a gas flow path, and pressing the pair of gas diffusion layers to form a plurality of gas diffusion layer protrusions that protrude towards a corresponding one of the catalyst layers from the gas diffusion layer and enter the corresponding one of the catalyst layers on the catalyst layer side on the gas diffusion layer, form the gas flow path opposite the corresponding one of the catalyst layers on the gas diffusion layer, and form a plurality of catalyst layer recesses on a gas diffusion layer side on the catalyst layer.

8. The method for producing a membrane electrode assembly according to claim 7, wherein in the pressing, the protrusion of one of the pair of molds and the protrusion of another of the pair of molds are disposed at positions overlapped along a thickness of the membrane electrode assembly.
